(19) United States
(12) Patent Application Publication
(10) Pub. No.: US 2018/0330056 A1
(43) Pub. Date: Nov. 15, 2018

(54) Methods of Processing and Classifying Microarray Data for the Detection and Characterization of Pathogens

(71) Applicant: InDevR Inc., Boulder, CO (US)

(72) Inventors: Robert STOUGHTON, Boulder, CO (US); Amber W. TAYLOR, Boulder, CO (US); Andrew W. SMOLAK, Boulder, CO (US); Erica Dawson TENENT, Boulder, CO (US); Rebecca H. BLAIR, Boulder, CO (US); Kathy L. ROWLEN, Boulder, CO (US)

(21) Appl. No.: 15/740,756

(22) PCT Filed: Jun. 30, 2016
(86) PCT No.: PCT/US16/40548

§ 371 Date: Dec. 28, 2017

Related U.S. Application Data
(60) Provisional application No. 62/187,947, filed on Jul. 2, 2015.

(51) Int. Cl. G06F 19/24; G06N 3/08; G06F 19/22; G06F 19/20; G06F 19/18

(52) U.S. Cl. CPC G06F 19/24; G06N 3/084; G06N 3/126; G06F 19/20; G06F 19/18; G06F 19/22

(57) ABSTRACT

The invention provides microarray systems and methods for pathogen identification and characterization. Aspects of the invention implement supervised learning for microarray data analysis to enhance the accuracy and scope of genomic and diagnostic information obtained. Embodiments of the invention, for example, utilize structured logical combinations of the output of independent supervised learning algorithms, such as artificial neural network (ANN) algorithms, to provide an efficient and rapid pathway to clinically and epidemiologically relevant diagnostic information.

### CROSS-REFERENCE TO RELATED APPLICATIONS

This application claims the benefit of priority to U.S. Provisional Patent Application No. 62/187,947 filed on Jul. 2, 2015, which is specifically incorporated by reference to the extent not inconsistent herewith.

### STATEMENT REGARDING FEDERALLY SPONSORED RESEARCH OR DEVELOPMENT

This invention was made with government support under Contract number HHSO100201400010C awarded by the Biomedical Advanced Research and Development Authority (BARDA), Office of the Assistant Secretary for Preparedness and Response, U.S. Department of Health and Human Services. The government has certain rights in the invention.

### BACKGROUND OF INVENTION

Modern clinical practice often relies on typing or genotyping to effectively diagnose and treat pathogenic infection. In response to this need, a range of diagnostic approaches have been developed providing clinically relevant information.

Approaches for pathogen characterization based on biomarker identification have been demonstrated to provide the capability for rapid sample evaluation, including RT-PCR based probe sequence amplification and/or immunoassay approaches. A drawback of conventional biomarker-based approaches for pathogen characterization is that they generally provide a relative low information content and are susceptible to a loss of detection efficiency and selectivity to genetic mutation. Alternatively, approaches based on full genome sequencing are available that provide very high information content, for example, via conventional and next generation sequencing techniques. Full genome sequencing approaches are labor and time intensive and, thus, are generally recognized as difficult to implement in point of care and near patient testing.

Microarray-based methods have also been developed for pathogen identification and characterization. Advantages of microarray techniques include the potential for greater diagnostic information content given the use of multiple, complementary capture sequences. These techniques also provide for rapid and sensitive optical readout and are compatible with straightforward sample processing and handling, thus providing the potential for point of care applicability. In the context of influenza treatment, for example, micro-array based assays have emerged as a particularly promising platform for providing accurate and rapid characterization of influenza type, subtype, and seasonal strain information [see, e.g., Heil, G L. et al. “MChip, a low density microarray, differentiates among seasonal human H1N1, classical swine H1N1, and the 2009 pandemic H1N1”, Influenza Other Respir Viruses 2010, 4(6), 411-416, Moore, C L et al., “Evaluation of MChip with Historic A/H1N1 Influenza Viruses Including the 1918 “Spanish Flu’” J Clin Microbiol 2007, 45(11), 3807-3810; and U.S. Patent Publications 2009/0124512 and 2010/0130378].

Despite these advantages, challenges remain for exploiting the full potential of microarray-based approaches for pathogen characterization including addressing decreases in hybridization efficiency originating from mutations and the potential for interference arising from cross-hybridization with non-influenza virus nucleic acids present in a sample. Important to the clinical implementation of microarray-based assays, therefore, is the development of data processing and analysis techniques capable of enhancing the overall diagnostic information content provided by these methods. Advances in microarray analysis techniques, for example, have potential to increase the accuracy and broaden the scope of diagnostic information obtained by microarray techniques.

It will be appreciated from the foregoing that there is currently a need in the art for improved systems and methods of pathogen identification, typing and subtyping. In particular, systems and methods of providing reliable, higher content genomic information are needed. Further, systems and methods that are capable of rapidly identifying and characterizing pathogen mutation(s) are needed.

### SUMMARY OF THE INVENTION

The invention provides microarray-based systems and methods for pathogen identification and characterization. Aspects of the invention implement supervised learning for microarray data analysis to enhance the accuracy and scope of genomic and diagnostic information obtained. Embodiments of the invention, for example, utilize structured logical combinations of the output of independent supervised learning algorithms, such as artificial neural network (ANN) algorithms, to provide an efficient and rapid pathway to clinically and epidemiologically relevant diagnostic information.

Other aspects of the invention implement unsupervised learning to identify novel patterns in the input data that may represent previously unidentified variations of a target pathogen. In one embodiment, a K-means clustering algorithm is applied to some or all of the inputs, allowing multiple samples that share the unidentified variation to be identified as belonging to a new group. Supervised learning algorithms as described above can then be applied to the data to develop an algorithm, such as an ANN, that identifies this new variation.

Microarray analysis methods of some embodiments of the invention implement machine learning using training data sets corresponding to well-characterized samples having known properties to providing pathogen characterization including type, subtype, seasonal strain and the presence of mutations and/or markers. The structured supervised learning aspect of some embodiments is compatible with straightforward retraining of supervised learning algorithms to respond to mutations due to antigenic drift or antigenic shift and characterize new pathogen strains. The invention also provides data preprocessing approaches complementary to the present microarray analysis techniques for enhancing the accuracy and information content of microarray data.

In an aspect, the invention provides a method for characterizing one or more target pathogens, the method comprising: (i) providing a microarray having a plurality of capture sequences; (ii) contacting the microarray with a sample derived from a material potentially containing the target pathogens, wherein analytes in the sample bind to a least a portion of the plurality of capture sequences; (iii) reading out the microarray contacted with the sample, thereby generating microarray data; (iv) analyzing the microarray data using a plurality of independent supervised learning algorithms; wherein at least a portion of the independent supervised learning algorithms independently provide outputs corresponding to pathogen parameters of the one or more target pathogens, wherein each of the independent supervised learning algorithms are independently trained using supervised learning with training microarray data sets corresponding to training samples characterized by one or more known pathogen parameters; and (v) combining the outputs for at least a portion of the independent supervised learning algorithms to make a determination, thereby characterizing the one or more target pathogens. In some embodiments, the method makes a determination corresponding to the presence or absence of a target pathogen. In some embodiments, the method makes a determination corresponding to a feature of a target pathogen, such as pathogen type, subtype, strain, lineage, seasonality, presence of mutations, etc.

Methods and systems of embodiments of the invention are versatile and, thus, compatible with characterization of pathogen parameters corresponding to a wide range of samples, including deep genotype characterization of influenza virus in clinical samples, isolates or other samples. In an embodiment, for example, the material potentially containing the target pathogens is a biological material from a human or a non-human animal. In an embodiment, the material potentially containing the target pathogens is a clinical specimen. In embodiments, the material potentially containing the target pathogens is a material grown in cell culture, an egg culture or grown by other methods. In an embodiment, for example, the material potentially containing the target pathogens is an environmental material that is suspected of containing influenza.

In an embodiment, the method further comprises a step obtaining and processing the material potentially containing the target pathogens, thereby generating the sample. In an embodiment, the method further comprises a step treating a patient on the basis of diagnostic information obtained using the present methods. In an embodiment, for example, the determination is an identification of the presence or absence of the one or more target pathogens, or, for example, one or more pathogen parameters of a target pathogen. In an embodiment, the method further comprises the step of retraining at least a portion of the independent supervised learning algorithms so as to recognize a new strain of the one or more target pathogens.

Different types of algorithms may be implemented to enhance the capabilities of the supervised learning methods in the disclosed invention. Further, different types of algorithms may be used in conjunction to increase efficiency and efficacy of the pathogen identification. Supervised learning algorithms may also be used to analyze different pathogen characteristics or be trained (including retraining) using a wide range of supervised learning techniques and training microarray data.

In an embodiment, for example, each of the independent supervised learning algorithms is independently trained to evaluate a single pathogen parameter of a target pathogen. In an embodiment, each of the independent supervised learning algorithms is independently trained to evaluate a different pathogen parameter of one or more the target pathogens. In an embodiment, 2 to 20 independent supervised learning algorithms are used to analyze the microarray data. In an embodiment, at least a portion of the independent supervised learning algorithms are independent artificial neural network (ANN) algorithms.

In embodiments, for example, at least a portion of the independent supervised learning algorithms are selected from the group consisting of: a support vector machine; a decision tree; a clustering algorithm, a Bayesian network, a random forest, a logistic regression algorithm, a K-nearest neighbor algorithm, and any combination thereof. In an embodiment, at least a portion of the independent supervised learning algorithms are independently trained via a backpropagation method. In embodiments, at least a portion of the independent supervised learning algorithms are independently validated using a k-fold cross-validation method. In embodiments, for example, at least a portion of the independent supervised learning algorithms are independently trained or validated using 10 to 1000 pre-characterized training samples, or for example, 2 to 10000 pre-characterized training samples.

In an embodiment, at least a portion of the independent supervised learning algorithms are trained solely on a single known pathogen type to identify the presence or absence of one or more distinguishing attributes or pathogen subtypes. In an embodiment, at least a portion of the independent supervised learning algorithms are independently trained using training microarray data for training samples characterized by the presence of a target pathogen having one or more known pathogen parameters. In an embodiment, at least a portion of the independent supervised learning algorithms are independently trained using training microarray data corresponding to samples confirmed to exhibit the corresponding pathogen feature or features of interest.

In an embodiment, the independent supervised learning algorithms are independently trained by identifying features in the training microarray data for training samples corresponding to known pathogen parameters of the target pathogens. In embodiments, for example, the known pathogen parameters are selected from the group consisting of: type, subtype, genotype, absence of pathogen, strain, lineage, seasonality, human or animal host to which the virus has adapted, mutation presence or absence, marker presence or absence, and any combination of these. In embodiments, the pathogen is one or more influenza viruses and the pathogen parameters correspond to influenza A, influenza B, influenza A seasonal H1N1 subtype, influenza A seasonal H3N2 subtype, influenza A non-seasonal subtype, H5N1 subtype, H5N2 subtype, H7N9 subtype, H9N2 subtype, H3N8 subtype, pathogenicity marker, 275Y NA mutation or 119V NA mutation.

In an embodiment, at least a portion of the independent supervised learning algorithms are independently trained using training microarray data for training samples characterized by the absence of the target pathogens. In an embodiment, at least a portion of the independent supervised learning algorithms are independently trained using training microarray data for training samples confirmed to lack the corresponding pathogen feature or features of interest. In an embodiment, for example, the pre-characterized training samples characterized by the absence of the target pathogens are derived from a sample containing human or non-human animal DNA.

Training microarray data may be obtained corresponding to a wide range of pre-characterized samples including samples known to contain one or more pathogens or samples known not to contain certain target pathogens or known not to contain any pathogens. In an embodiment, at least a portion of the independent supervised learning algorithms utilize a reduced set of inputs derived from a total set of inputs via Principal Component Analysis.

The systems and methods provided herein are useful to identify and characterize pathogens with regards to a wide variety of pathogen features.

In an embodiment, each of the independent supervised learning algorithms independently provide an output comprising a score characterizing similarities or differences of the microarray data with at least a portion of the training data sets. In an embodiment, at least a portion of the independent supervised learning algorithms each independently provides a score corresponding to a pathogen parameter of the target pathogens. In an embodiment, for example, each of the independent supervised learning algorithms independently provides a score corresponding to a different pathogen parameter of the target pathogens.

In embodiments, for example, the pathogen parameters are selected from the group consisting of: type, subtype, genotype, absence of pathogen, strain, human or animal host to which the virus has adapted, mutation presence or absence, marker presence or absence and any combination of these for the target pathogens. In embodiments, each score is independently compared to a corresponding threshold to determine if the output is positive or negative for a given pathogen parameter. In an embodiment, for example, each threshold is independently determined by maximizing positive percentage agreement with the training set, negative percentage agreement with the training set or both.

In an embodiment, outputs of at least a portion of the independent supervised learning algorithms are logically combined to make the determination. In an embodiment, logically combining the outputs comprises identifying the absence of a target pathogen. In an embodiment, logically combining the outputs comprises identifying if a target pathogen is detected. In an embodiment, logically combining the outputs comprises identifying pathogen type if the target pathogen is detected. In embodiments, for example, if the target pathogen is detected, then logically combining the outputs further comprises: (a) identifying pathogen type; (b) identifying pathogen subtype; (c) identifying pathogen genotype; (d) identifying pathogen linage; (e) identifying if the pathogen contains targeted mutations; (f) identifying if the pathogen contains markers; (g) identifying host to which pathogen is adapted; or (h) any combination of these. In an embodiment, for example, logically combining the outputs comprises determining if an influenza A or influenza B target pathogen is detected. In an embodiment, in the event influenza B is identified, logically combining the outputs further comprises identifying the lineage of the influenza B target pathogen. In an embodiment, in the event influenza B is identified, logically combining the outputs further comprises identifying a Yamagata lineage or a Victoria lineage.

In embodiments, for example, in the event influenza A is identified, logically combining the outputs further comprises identifying seasonal H1N1, seasonal H3N2 or non-seasonal subtype (which may include non-seasonal strains of H1N1 or H3N2). In an embodiment, in the event influenza seasonal H1N1 is identified, logically combining the outputs further comprises identifying the presence or absence of a 275Y NA mutation characteristic. In an embodiment, in the event influenza seasonal H3N2 is identified, logically combining the outputs further comprises identifying the presence or absence of a 119V NA mutation characteristic. In an embodiment, for example, in the event non-seasonal subtype is identified, logically combining the outputs further comprises identifying H5N1, H5N2, H7N9, H9N2, or H3N8 subtype. In an embodiment, for example, in the event non-seasonal H5N1 subtype is identified, logically combining the outputs further comprises identifying a pathogenicity marker or pathogen mutation.

In an embodiment, in the event influenza A is identified, Independent networks identify the HA subtype and the NA subtype. These can be single- or multi-neuron ANNs that are trained to recognize the specific HA and NA gene geometries (e.g., H1, H3, H5, H7 H9, and N1, N2, N7, N8 & N9). In one embodiment, independent single-neuron ANNs identify each HA and NA subtype of interest (i.e., one ANN identifies H1, a second identifies H3, etc.). These networks may be trained using all of the inputs, or may use only a subset of the inputs. As an example, the HA networks may be trained using only signals from capture sequences designed specifically to capture the HA gene segment, and the NA networks may be trained using only signals from capture sequences designed specifically to capture the NA gene segment. It will be obvious that any combination of inputs may also be used. For example, the HA networks may be trained using signals from both HA and M gene specific capture sequences, or any other combination of inputs.

In an embodiment, for example, the pathogen is influenza A and at least one of the plurality of independent supervised learning algorithms provides outputs corresponding to HA subtype and at least one of the plurality of independent supervised learning algorithms provides outputs corresponding to NA subtype. In embodiments, the at least one of the plurality of independent supervised learning algorithm which provides outputs corresponding to HA subtype is trained using signals from capture sequences designed to capture the HA gene segment or the at least one of the plurality of independent supervised learning algorithm which provides outputs corresponding to NA subtype is trained using signals from capture sequences designed to capture the NA gene segment.

In an embodiment, networks may be trained to identify the differences between similar virus subtypes which have adapted to different animal hosts. As an example, an ANN can be trained to differentiate between H1 strains that are human-adapted and those that are adapted to non-human animals. Networks may be further trained to identify specific animal hosts. For example, one network may identify H1 viruses with avian host adaptation, while another identifies H1 viruses with porcine host adaptation.

In an embodiment, for example, the output of the independent supervised learning algorithms is only used for further pathogen characterization depending on the logical output of one or more independent supervised learning algorithms corresponding to the pathogen type it was trained upon.

The systems and methods of this invention can be used with a wide range of microarray systems, sample handling techniques and readout methods. Further, additionally pre-processing steps may be included to increase pathogen identification accuracy, reducing false positives or false negatives, and reducing the risk of interferences, such as arising from microarray defects, contamination, sample processing, etc.

In an embodiment, the invention further comprises measuring a labeling control, a hybridization control or both. In an embodiment, wherein if a labeling control, hybridization control or both fail to reach their threshold values then an assay failure is determined.

In embodiments, for example, the microarray is characterized by between 100 and 1000 different types of capture sequences. In embodiments, the microarray capture sequences are oligonucleotide capture sequences, oligopeptide capture sequences or a combination of both oligonucleotide capture sequences and oligopeptide capture sequences. In an embodiment, the step of reading out the microarray comprises measuring relative intensities of light from at least a portion of the capture sequences. In an embodiment, for example, the measuring intensities of light from at least a portion of the capture sequences is carried out by exposing the microarray to light and detecting scattered or emitted light from at least a portion of the capture sequences. In embodiments, wherein the intensities of light correspond to fluorescence from the capture sequences hybridized to oligonucleotides comprising a fluorescently-detectable label, or subsequently labeled, for example, using a streptavidin-coupled fluorophore.

In an embodiment, the method further comprises pre-processing the microarray data prior to the step of analyzing the microarray data. In embodiments, for example, the pre-processing comprises calculating intensity values for a plurality of spots of the microarray corresponding to the same capture sequence and comparing the intensity values using means, medians, averages, weighted parameter analysis or other statistical parameters. In embodiments, the pre-processing comprises statistically combining (etc. using medians, averages or weighted averages) intensity values corresponding to a subset of the plurality of spots of the microarray corresponding to the same capture sequence. In an embodiment, for example, the step of pre-processing the microarray data is carried out using a nearest neighbor analysis in which only a subset of values of the same capture sequence that are closest together are statistically combined. In an embodiment, each of the capture sequences is provided in replicates corresponding to a plurality of spots on the microarray, wherein intensity values of at least two spots meeting a predetermined criterion are used to determine the intensities. In an embodiment, each of the capture sequences is provided in triplicate on the microarray, wherein median intensity values of two spots that are closest in value are combined or averaged to determine the intensities.

The invention is versatile and thus, is useful for a variety of pathogen identification applications, including identification of a range of viruses and bacteria in samples. For example, the invention may be used to identify and characterize viruses, including influenza. Further, the invention may be used to identify a wide variety of types, strains or mutations of similar pathogens. In an embodiment, for example, the invention is a method for determining the presence or absence of influenza virus. In embodiments, the method is for determining the type, subtype, genotype, lineage, pathogenicity, strain or any combination of the influenza virus. In embodiments, for example, the method is for determining if the influenza virus is influenza A, influenza B, influenza A seasonal H1N1 subtype, influenza A seasonal H3N2 subtype or influenza A non-seasonal subtype. In an embodiment, the influenza A non-seasonal subtype is further subtyped by specific hemagglutinin (HA) type, neuraminidase (NA) type, or both. In an embodiment, for example, the method is for determining if the influenza virus contains mutations that are putative markers of antiviral resistance.

In an embodiment, data collected from multiple systems is uploaded to a central database, allowing near real-time surveillance of data collected across a wide region. New data can be analyzed using unsupervised learning algorithms (such as K-means clustering) to identify similar, novel patterns appearing in proximal regions. All of the samples identified as belonging to the new cluster can be used, in conjunction with an established training database of samples, to train new ANN using supervised learning algorithms. This approach allows identification of a potential pandemic outbreak with an extremely fast response time.

In an aspect, the invention is a method for analyzing microarray data for characterizing one or more target pathogens, the method comprising: (i) providing the microarray data; (ii) analyzing the microarray data using a plurality of independent supervised learning algorithms; wherein at least a portion of the independent supervised learning algorithms independently provide outputs corresponding to pathogen parameters of the one or more target pathogens, wherein each of the independent supervised learning algorithms are independently trained using supervised learning with training microarray data sets corresponding to pre-characterized training samples characterized by one or more known pathogen parameters; and (iii) combining the outputs for at least a portion of the independent supervised learning algorithms to make a determination, thereby characterizing the one or more pathogens.

In another aspect, the invention is a system for analyzing microarray data for characterizing one or more target pathogens, the system comprising a processor configured to: (i) receive microarray data as an input; (ii) analyze the microarray data using a plurality of independent supervised learning algorithms; wherein at least a portion of the independent supervised learning algorithms independently provide outputs corresponding to pathogen parameters of the one or more target pathogens, wherein each of the independent supervised learning algorithms are independently trained using supervised learning with training microarray data sets corresponding to pre-characterized training samples characterized by one or more known pathogen parameters; (iii) combine the outputs for at least a portion of the independent supervised learning algorithms to make a determination; and (iv) generate a diagnostic output corresponding to the determination, such as a clinical positive, clinical negative or pathogen characterization determination.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1. A schematic diagram depicting the training architecture and interpretation architecture for an exemplary method of the invention.

FIG. 2. A flow diagram of a decision tree for combining the outputs of individual supervised learning algorithms for making a determination, such as the characterization of a sample.

FIG. 3. Representative microarray signal patterns for different influenza virus categories of interest.

FIG. 4. Microarray data showing differences between low, middle, and high intensity spots for triplicate printed capture sequences (data represents ˜210,000 datapoints) before the nearest-neighbor averaging (left side) and after the nearest-neighbor averaging (right side).

FIG. 5. A flow diagram of an example training/validation process. In this embodiment, each ANN is typically designed to recognize a single type or subtype.

FIG. 6. Perceptron architecture of simple Artificial Neural Network (ANN) where each diamond shown in the figure represents an ANN with the architecture shown here.

FIG. 7. A high level flow diagram providing an overview of a data analysis method of the invention.

FIG. 8. A flow diagram illustrating an example clinical sample decision tree.

FIG. 9. A flow diagram illustrating an alternative example clinical sample decision tree.

FIG. 10. A schematic diagram depicting the training architecture and interpretation architecture for an exemplary method of the invention in which multiple levels of information are extracted and presented.

### DETAILED DESCRIPTION OF THE INVENTION

In general, the terms and phrases used herein have their art-recognized meaning, which can be found by reference to standard texts, journal references and contexts known to those skilled in the art. The following definitions are provided to clarify their specific use in the context of the invention.

“Pathogen” refers to an infectious agent such as a virus or bacterium. Target pathogen refers to a pathogen in a sample under analysis, for example, having specific characteristics, such as type, subtype, genotype, absence of pathogen, strain, lineage, or seasonality. The present methods and systems are useful for determining the presence, absence and/or characteristics or target pathogens in a sample.

“Supervised learning” is a subset of machine learning algorithms, within the field of pattern recognition. “Supervised learning algorithm” is an algorithm that utilizes supervised learning for the purpose of identifying and/or characterizing features in an input, such as in microarray data. In some embodiments, supervised learning algorithms of the invention identify and/or characterize features in microarray data corresponding to a target pathogen such as a pathogen parameter. “Independent supervised learning algorithms” refers to a plurality of supervised learning algorithms that operate independently to receive and analyze microarray data, for example, so as to provide outputs corresponding to pathogen parameters. “Independent supervised learning algorithms” may operate in parallel or in sequence. Embodiments of the invention use a plurality of independent supervised learning algorithms that are trained using microarray data for known samples. Embodiments of the invention logically combine the output plurality of independent supervised learning algorithms to make a determination, such as indicating the presence or absence of a target pathogen, characterizing features of a target pathogen, or otherwise providing diagnostically relevant information.

“Unsupervised learning” (or “Unstructured learning”) is also a subset of machine learning algorithms, within the field of pattern recognition. “Unsupervised learning algorithm” is an algorithm that utilizes unsupervised learning for the purpose of identifying and/or characterizing new or previously unrecognized features in a dataset, such as in microarray data. In some embodiments, unsupervised learning algorithms of the invention identify and/or characterize features in microarray data corresponding to a new or emerging target pathogen (such as a pathogen parameter) for which prior identified patterns are not available. In some embodiments, unsupervised learning in the form of cluster analysis is performed to identify a group of samples that correspond to an emergent pattern. Supervised learning can then be used to develop new algorithms to identify the emergent pattern in subsequent data.

“Pathogen parameter” refers to a characteristic or feature of a pathogen, such as a target pathogen. Pathogen parameters include the presence or absence of a target pathogen. Pathogen parameters include type, subtype, genotype, absence of pathogen, strain, lineage, seasonality, host species adaptation, presence or absence of a mutation, or presence or absence marker. In the context of influenza target pathogens, for example, pathogen parameters include identification or classification of influenza A, influenza B, influenza A seasonal H1N1 subtype, influenza A seasonal H3N2 subtype, influenza A non-seasonal subtype, H5N1 subtype, H5N2 subtype, H7N9 subtype, H9N2 subtype, H3N8 subtype, individual HA subtypes (including, for example, H1, H3, H5, H7 & H9), individual NA subtypes (including, for example, N1, N2, N7, N8 and N9), pathogenicity marker, 275Y NA mutation, 119V NA mutation, 292K mutation or 155H mutation.

“Sample” refers to a composition derived from a material, such as a material potentially containing target pathogens. Embodiments of the present methods are useful for analyzing samples derived from a wide range of materials including clinical samples, biological material from a human or a non-human animal, an environmental material that is suspected of containing influenza, a material grown in cell culture or an egg culture or grown by other methods. In some embodiments, a sample is derived by processing a material potentially containing target pathogens, such as processing involving extraction, amplification, fragmentation and/or purification of biological materials such as oligonucleotides and nucleic acids.

Aspects of the invention provide methods for processing and/or analyzing microarray data. The method is useful for rapidly identifying specific types, subtypes and/or strains of pathogenic infections present in clinical samples, isolates, or other samples suspected of containing pathogens. In embodiments, the method uses the intensities of various oligonucleotide capture sequences on a microarray as inputs to predict which type or subtype of pathogen is present using a mathematical model that utilizes supervised learning.

Supervised learning is a subset of machine learning algorithms, which falls into the broader field of pattern recognition. Machine learning is employed to learn from and make predictions based on complex data. More specifically these types of algorithms operate by constructing a mathematical model from example data that can be used to make predictions or decisions based on novel data. Supervised learning algorithms, which are employed in the invention, for example, may infer a predictive model from a “training” data set that consists of example input values paired with expected output values. Input values may consist of any pre-defined set of quantifiable features that can be extracted from each object presented to the algorithm. Output values can be associated with labeled categories, scores or other known characteristics of each object. The goal of the training phase to is generalize a function, or set of functions, that can then be used to recognize unseen and unique feature sets and determine their similarity to the objects presented during training. Output values correspond to the labels or classifications attributed to those known objects. In this manner, algorithms may be constructed to make broad or very specific classifications or decisions depending on the composition of the representative training set, number of outputs and the degree of function generalization.

Well-characterized samples that represent each different “category” or “class” of the pathogen to be identified (e.g., types, subtypes, serotypes, strains, etc.) are extracted, amplified, hybridized to a microarray, and imaged to generate an array of fluorescence intensities (for each capture sequence) utilized for training. In embodiments, samples containing other pathogens and samples containing no pathogens but containing human genetic material are also processed to generate microarray patterns for training as negatives. Microarray data from these well-characterized samples form a dataset that is used to train a set of pattern recognition algorithms to recognize the features of the various categories/classes, and those of clinical negatives.

In a preferred embodiment, numerous “building block” algorithms are individually trained to identify different classes or categories of the pathogen. Examples include a block to identify pathogen type (e.g., that may represent multiple subtypes that are all categorized as the same type), a specific pathogen subtype, or patterns wherein the target pathogen is not present (although other potentially interfering pathogens may be). The features used as inputs to the algorithms are the median spot intensities collected for each capture sequence. Each building block may output a value between 0 and 1, where a value closer to 1 indicates that the pattern of intensities for the unknown sample in question matches closely the pattern for the training set, and a value closer to 0 indicates the unknown sample in question does not match the pattern for the training set. The various building blocks are then linked together logically in order to make a final determination of the pathogen detection, for example, via a logical cascade architecture relating to the categories and subcatogories of pathogen parameters. In embodiments, thresholds, for example as defined as the value between 0 and 1 between making a “positive” and “negative” call, are chosen for each of the blocks in order to optimize the performance of the system as a whole.

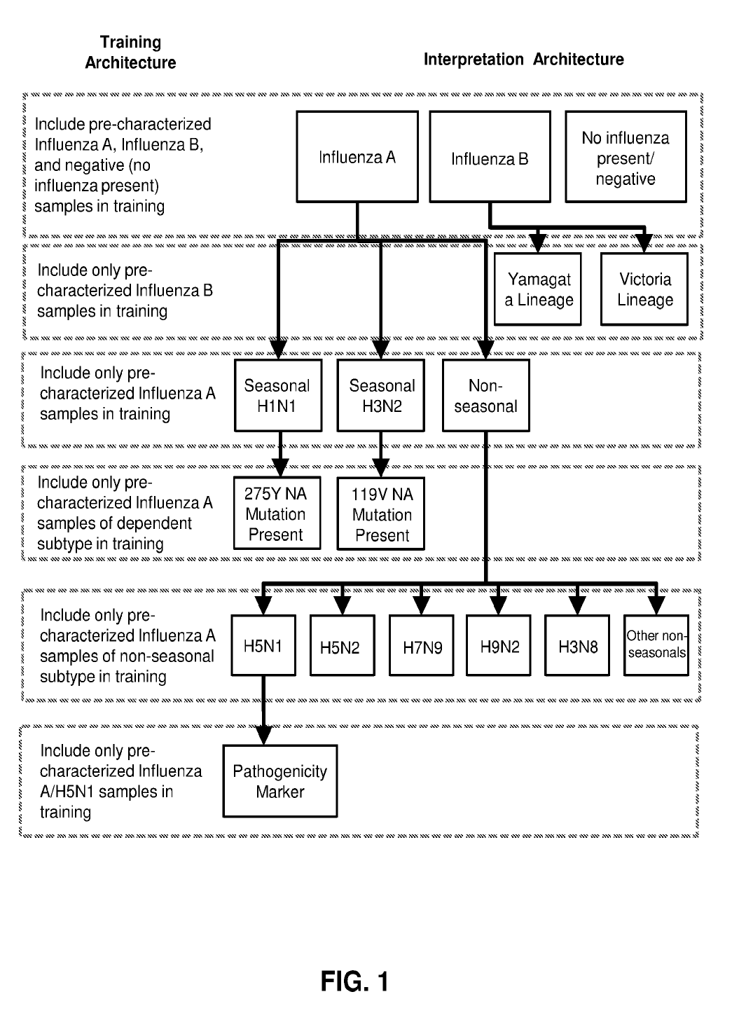

FIG. 1 provides a schematic diagram depicting the training architecture and interpretation architecture for an exemplary method of the invention. As depicted for this embodiment of the invention, both training and analysis for supervised learning algorithms are targeted to a specific pathogen parameter. In this embodiment, training involves samples that are pre-characterized as corresponding to a selected pathogen parameter. The interpretation architecture illustrates an approach wherein individual supervised learning algorithms analyze input microarray data for evaluation of a specific pathogen parameter. FIG. 1 also exemplifies a cascaded, logical approach for combining the output of a plurality of independent supervised learning algorithms, for example, wherein the outputs of various independent supervised learning algorithms are combined in a logical and nested framework. For example, identification of an influenza type is linked to subsequent analysis of related pathogen parameters such as subtype, original seasonality and the present of mutations or markers.

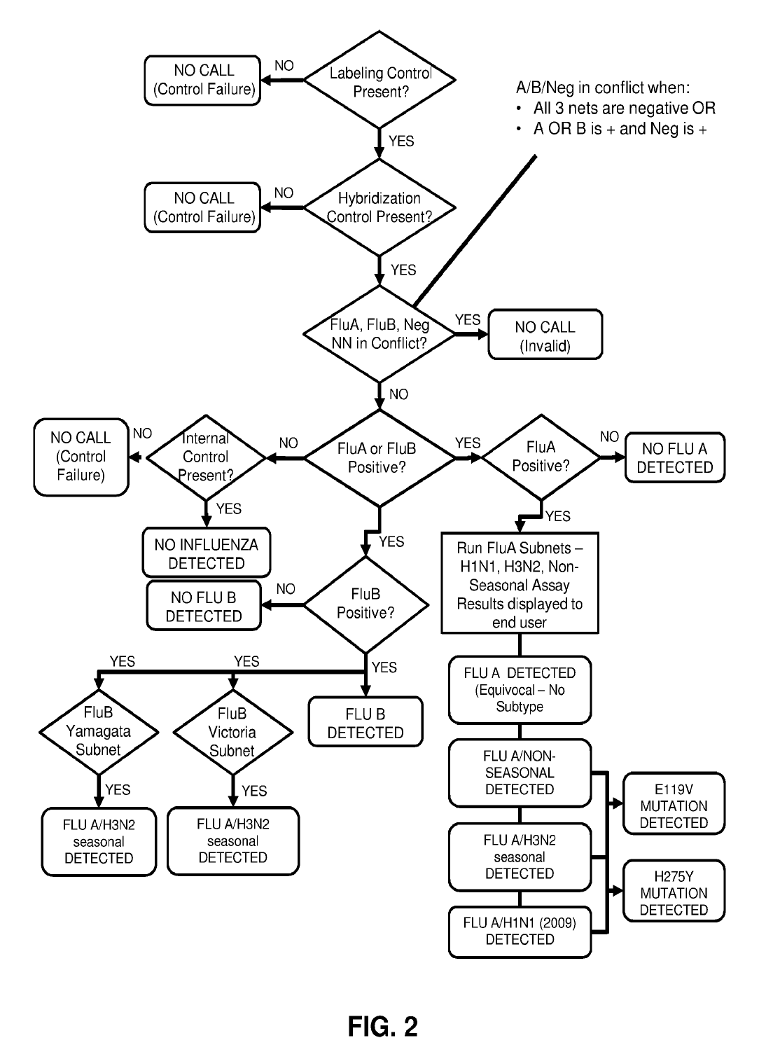

FIG. 2 provides a flow diagram showing the logical combinations of the outputs of individual supervised learning algorithms for making a determination, such as the characterization of a sample with respect to the presence, absence or characteristics of one or more target pathogens. An evaluation of labeling and hybridization controls is initially carried out to filter out microarray data sets that are potentially impacted by sources of interference, such as manufacturing defects, improper processing or handling, etc. Microarray data that passes labeling and hybridization controls is evaluated by independent supervised learning algorithms provided in a sequential and nested relationship. For example, supervised learning algorithms initially evaluate the microarray data for the presence of absence of influenza virus, and data for which influenza virus is affirmatively identified is subsequently analyzed by one or more separate supervised learning algorithms to characterize features of the influenza virus (e.g., type, subtype, origin, seasonality, host species adaptation, presence of mutations, etc.). As shown in FIG. 2, only the subset of supervised learning algorithms related to a particular determination is carried out, such as characterization of influenza A or influenza B pathogen parameters.

Relevant Influenza Virus Background—

In one embodiment, the invention is used to identify types and subtypes of influenza virus. Influenza virus belongs to the virus family Orthomyxoviridae and consists of an 8-piece segmented RNA genome that codes for 11 proteins. The segmented RNA genome makes the influenza virus prone to mutations, both due to errors in RNA replication (antigenic drift, which gives rise to seasonal epidemics) and drastic changes in the viral genome due to reassortment of genetic segments from different parent viruses (antigenic shift, which gives rise to pandemics). Influenza A viruses historically give rise to both epidemics and pandemics, whereas influenza B viruses give rise to only seasonal epidemics.

The types of influenza virus known to cause regular infections in humans and animals are referred to as A and B. Influenza type B is not as genetically diverse as influenza A, and is characterized by two different lineages (the Yamagata lineage and the Victoria lineage) based on phylogeny. In addition, influenza B mainly infects humans.

Influenza type A consists of a variety of subtypes, based on the makeup of the two surface proteins, hemagglutinin (HA) and neuraminidase (NA). There are currently 16 known HA subtypes and 9 known NA subtypes that combine in a variety of ways, giving rise to the standard HXNY nomenclature (ex: H3N2, H5N1). All influenza A viral subtypes have been isolated from wild aquatic birds (the natural reservoir of influenza virus), but infections occur in other animal species including humans. The most common influenza A subtypes infecting humans are H1, H2, H3, N1, and N2.

The currently circulating seasonal subtypes of influenza A are H1N1 and H3N2. “Non-seasonal” subtypes of influenza A (defined as those subtypes that are not seasonal H1N1 or seasonal H3N2) are numerous, and include but are not limited to many subtypes of higher prevalence in animals and/or potentially pandemic importance such as H5N1, H5N2, H7N9, H7N2, H7N3, H9N2, H7N7, H3N8, and H1N1 of swine and avian origin.

Training Process—

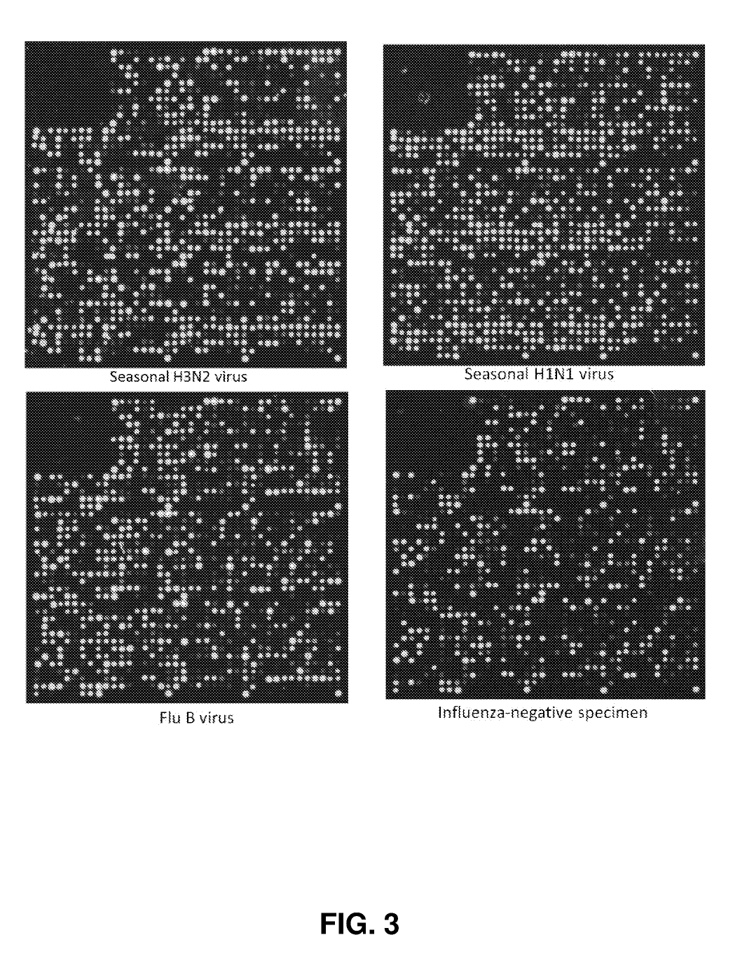

The methods of certain embodiments utilize a training dataset of well-characterized samples for proper identification (prediction) of category/class in unknown samples; it is therefore important that the training dataset include representative samples from different categories/classes that are to be identified. FIG. 3 provides examples of microarray data for seasonal H3N2 virus, seasonal H1N1 virus, Flu B virus and an influenza negative specimen that can be used for training via supervised learning in the present methods.

The categories of interest for influenza identification for clinical use, for example, are: 1) influenza A, 2) influenza B, 3) influenza A, seasonal H1N1 subtype, 4) influenza A, seasonal H3N2 subtype, 5) influenza A, non-seasonal subtype, and 6) no influenza present. From a broader surveillance perspective, additional categories of interest include the specific HA and NA subtypes, an indication of whether or not the virus has adapted to human hosts, and if adapted to a non-human host, the animal family to which it has adapted.

The various microarray capture sequences are designed to hybridize with fragments of amplified influenza nucleic acid, and represent a large fraction of the influenza viral genome. Due to the potential for cross-hybridization of microarray capture sequences with non-influenza virus nucleic acids in the form of human nucleic acids and/or nucleic acids from other pathogens that may be present in the material hybridized, it is important that patterns from these types of samples be included in the training set so that they are not misidentified as new patterns of influenza.

Data Preprocessing—

Since the algorithms use the intensity of the signal of the nucleic acid hybridized to the capture sequences on the array to identify types and subtypes, it is clear that the intensity values used as inputs should be as accurate as possible to result in the most accurate classification/categorization. The microarrays used to measure the specific capture intensities are subject to manufacturing errors such as missing spots, misshapen or misplaced spots. Any of these errors may result in an artificially low spot intensity. In addition, the assay process is subject to salt residue and/or dust contamination, either of which may generate artificially high intensity values.

Certain embodiments of the invention utilize data pre-processing, for example to improve signal quality. In one preferred method, referred to as nearest-neighbor averaging, each oligonucleotide on the microarray is printed 3 times. The 3 locations are printed independently (i.e., not sequentially) and are well-spaced throughout the area of the microarray. This approach greatly reduces the probability of an uncorrelated error affecting more than one of the three replicates of a single oligonucleotide. For each input (i.e. unique sequence on the chip), the two values that are closest together (nearest neighbors) are averaged to form the intensity value used. The third (outlying) value is discarded, regardless of whether or not the outlying value is above or below the average of the nearest neighbors.

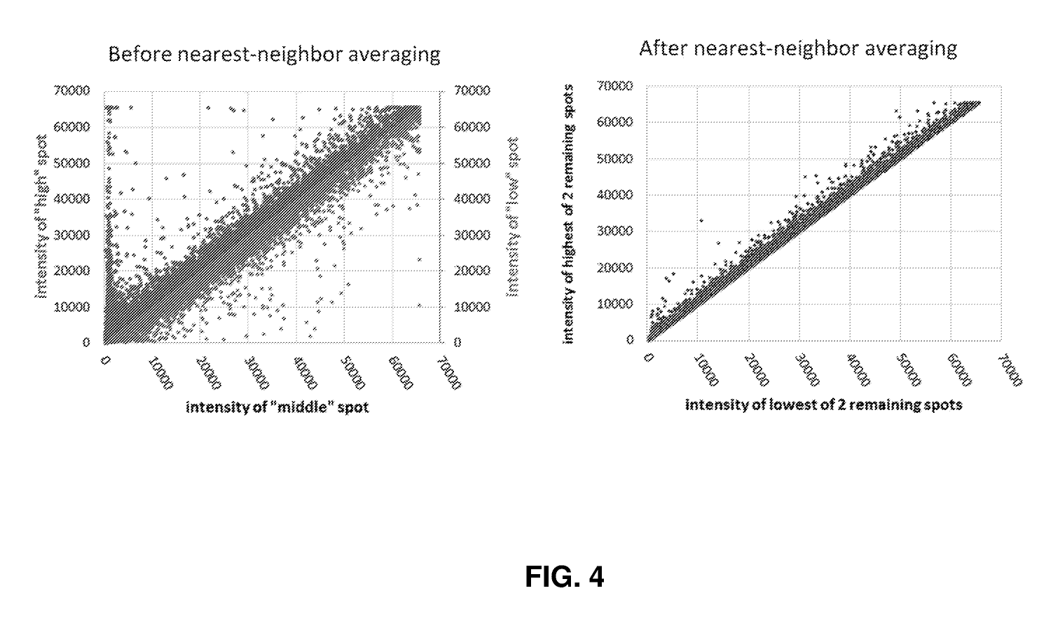

This method greatly improves the data quality when errors are relatively rare and uncorrelated. In some embodiments, for example, each of the 3 replicate spots for each capture sequence are ranked as “low”, “middle”, and “high” based on their relative intensities. In an embodiment, the data is plotted with the x axis on the left side representing the intensity of the spot with the middle intensity, the left-hand y axis representing the intensity of the spot with the highest intensity, and the right-hand y axis represents the intensity of the spot with the lowest intensity. A preprocessing data plot is obtained plotting the data for each triplicate set of spots as the two series. If all three spot values for a particular capture sequence are equal, the two datapoints for each triplicate set will appear along the line with slope=1. The off-diagonal points represent capture sequences for which the highest point or the lowest point are significant outliers compared to the middle spot, for example, caused by dust contamination/salt residue or a misprinted or “missed” spot, respectively. On the right side of a preprocessing data plot, the same dataset is plotted after the removal of the outlying spot. Scatter in the data is greatly reduced, and all of the outliers along the y axis are eliminated. While a few outliers may still be present, the percentage of points with outliers is reduced. In some instances, off-diagonal data points represent the rare instances for which 2 of the 3 replicates for a specific capture sequence were problematic. FIG. 4 provides scatter plots of microarray data before and after nearest neighbor averaging.

Training and Validation Process

In an embodiment, once the microarray data from the sample dataset has been generated and pre-processed, Artificial Neural Networks (ANNs), the type of machine learning algorithm used for supervised learning in this embodiment, are trained and their performance evaluated. A common approach to validating performance is a k-fold cross-validation method. In an embodiment, for example, the samples are randomly split into k subgroups, with (k−1) subgroups used to train the ANNs and the remaining subgroup used to validate the performance. This is repeated k times with each of the subgroups used once for validation. In splitting the samples into subgroups, it is important that the subgroups be as generically equivalent as possible. To this end, the samples may be first be split into subgroups consisting of the subtypes to be identified, then the subtype groups should be allocated evenly to each of the k subgroups for training/testing. This ensures that each time the ANNs are trained, all subtypes are represented in the training. The larger the number of subgroups used, the larger the training set, and (typically) the better the performance. Since each subtype should be included in each subgroup, and some subtypes are rare and difficult to obtain, the availability of subtype samples may pose a practical limitation to the number of subgroups used. Also, adding more subgroups increases the effort required to perform the validation, but may offer diminishing returns as the size of the training group used approaches the complete dataset (i.e., ½, ⅔, ¾, ⅘, . . . ). For some applications, six subgroups were found to be a good balance of validation performance and effort required. In some embodiments, once validation is complete, for example, the final ANNs may be trained using the complete dataset for use with novel samples.

Training of the ANNs is typically performed using standard backpropagation methods. Convergence criteria are typically defined when the average error is below a threshold, and that all or nearly all, training samples are identified correctly within a given amount (for example, 0.003). Since a given sample is either positive or negative, the “correct” value is either 0 or 1. For an ANN that uses a sigmoid output function that varies from 0 to 1 and a 0.003 convergence cutoff, this means that all (or nearly all) negative samples must generate an output less than 0.003 and all (or nearly all) positive samples must generate an output greater than 0.997.

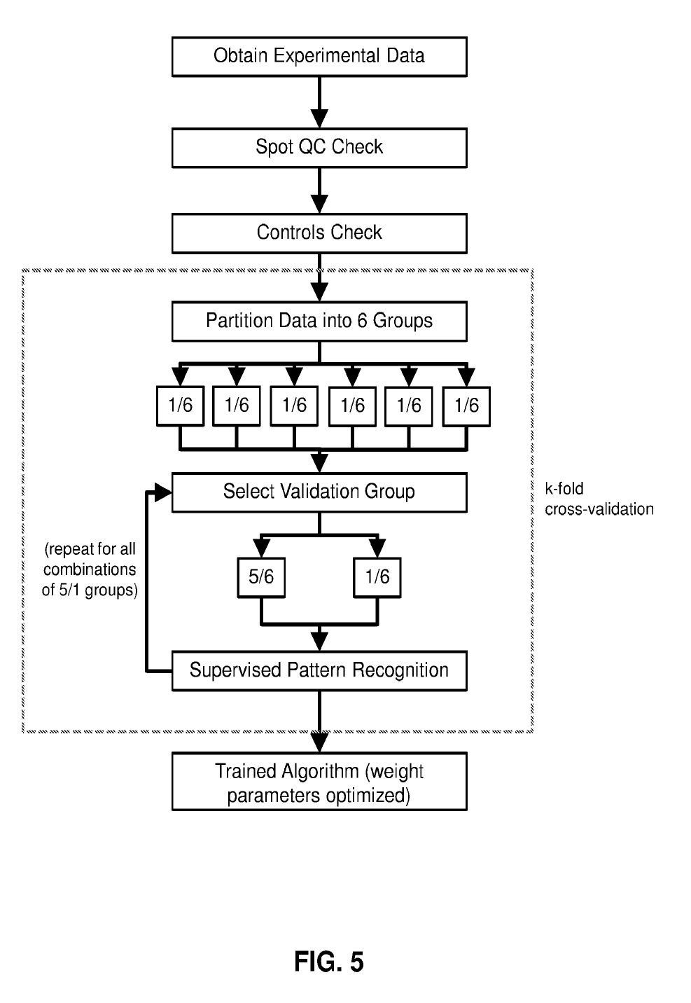

FIG. 5 provides a flow diagram of an example training/validation process. In this embodiment, each ANN is typically designed to recognize a single type or subtype. This approach allows for a simplified and effective architecture for the individual ANNs. In its simplest form, inputs are gathered into a single hidden node (perceptron). Each input has its own weight factor (these are the parameters that are trained during the training process). The sum of all the weighted inputs is then input into a (typically sigmoid) output function that generates a continuous output between 0 and 1. Of course, more complex architectures could also be used, with multiple hidden nodes, and potentially multiple outputs (corresponding to the different subtypes) could also be used.

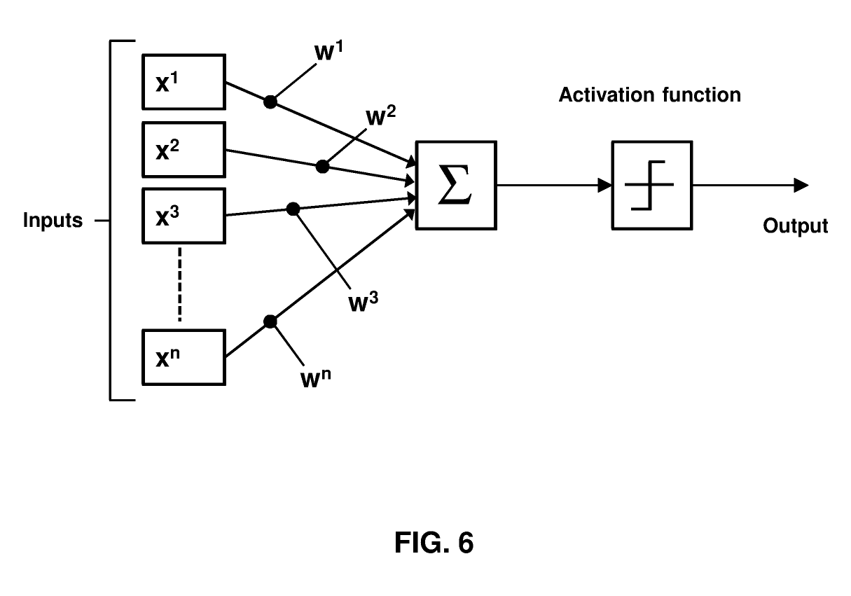

FIG. 6 schematically shows a perceptron architecture of a simple Artificial Neural Network (ANN) where each diamond shown in the figure represents an ANN with the architecture as described herein.

Depending on the number of oligonucleotides present on the microarray, the number of inputs into each ANN can be quite large. In an embodiment, for example, there may be 460 independent oligonucleotides designed to capture pieces of influenza-related nucleic acid, each spotted in triplicate. The characteristic pattern of various influenza types may be a linear combination of the individual oligonucleotide intensities.

Accurately and consistently identifying a recognizable pattern often requires a wide and diverse array of data from well-characterized samples in order to train the algorithm. The samples should provide examples that illuminate the boundary areas of the pattern, making it possible to distinguish the borders of what is and what is not part of group in question, and which input parameters are of significance in making that determination. Also, the cleaner the sample data, the fewer samples are needed. Towards this end, the following approach was used.

ANN Logical Combinations

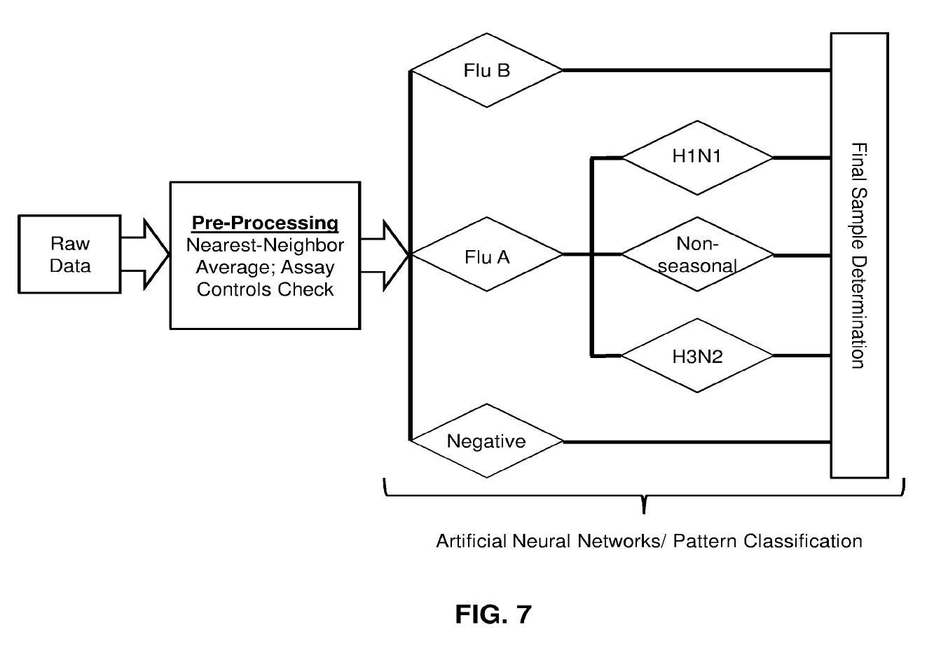

Once the individual ANNs have be trained, they can be further linked together logically in order to provide the most robust diagnostic output. FIG. 7 provides a high level flow diagram providing an overview of a data analysis method of the invention. For example, one ANN may be trained to recognize all influenza A types, another may be trained to recognize only a seasonal influenza A, subtype H3N2, and a third ANN may be trained to recognize negative clinical samples (including samples that may include non-influenza pathogens). These can be logically linked together such that a diagnostic output of seasonal influenza A, subtype H3N2 requires that both the Type A ANN and the Type A, subtype seasonal H1N1 ANN be positive, and the Negative ANN be negative. Conflicting outputs (e.g., all 3 ANNs are positive, or Type A ANN is negative while a Type A subtype is positive) may be considered invalid, with re-testing recommended.

One method of interlinking the individual ANNs is schematically illustrated in FIG. 2. This flowchart includes analysis of labeling and hybridization controls. In an embodiment, these are specific spots on the microarray that must have intensity values greater than pre-determined threshold values to ensure that the assay process has completed successfully. The block Influenza Detected is the OR of all of the influenza type and subtype ANNs (i.e., are any of the influenza ANNs positive?). Note that the thresholds used for each ANN to determine whether the output is positive or negative may be adjusted in order to optimize the overall performance. Optimizing the performance involves maximizing the Positive Percent Agreement (PPA) and Negative Percent Agreement (NPA), and minimizing the number of samples considered invalid. These goals may represent a tradeoff, in which case the balance between these objectives must be determined by overall performance objectives and/or requirements.

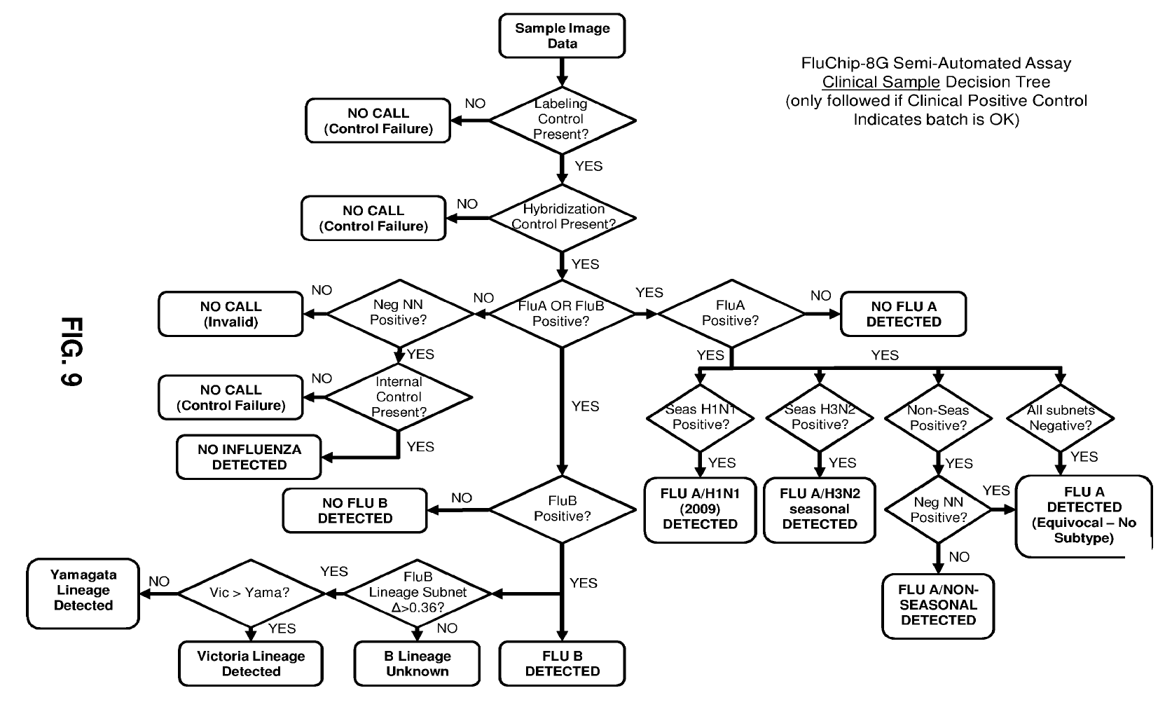

An alternative method of interlinking the individual ANNs is schematically illustrated in FIG. 9. In this method, the Influenza Negative net is only checked if neither the FluA nor the FluB net is positive. This can improve the sensitivity of the system by giving a positive output in the presence of a low-level infection in which the Influenza Negative net reports positive. Still another alternative method is also illustrated in FIG. 9. When a non-seasonal Flu A is detected, the Influenza Negative net can be checked. If it is positive, an output of “Flu A detected”, but not “Non-seasonal Flu A detected”, is generated. This can help to prevent false positive detection of “Non-seasonal Flu A”.

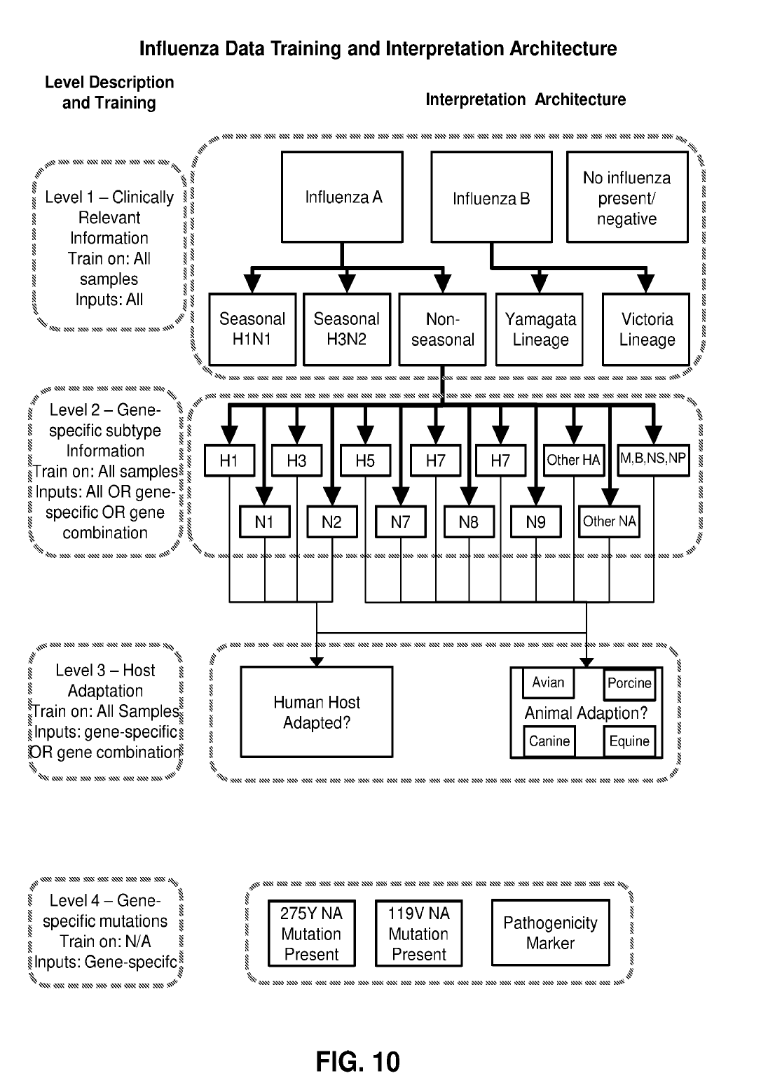

Another embodiment for an alternative method of interlinking the individual ANNs and presenting the results is shown in FIG. 10. In this embodiment, multiple levels of information are derived in a cascading architecture. In this example, Level 1 represents the clinically-relevant information described earlier and Level 2 information is specific to non-seasonal Flu A samples. Individual ANNs identify the specific HA and NA subtypes of the sample. Note that other influenza gene segments (matrix (M), non-structural (NS), and nucleoprotein (NP) in particular) may also be identified. In training the gene segment-specific ANNs, all samples (including seasonal Flu A, Flu B and negative samples) may be used, or the training set may be limited to only Flu A or non-seasonal Flu A samples. The use of all samples tends to help minimize the number of false positives. The individual ANNs may also be trained by utilizing only at signals generated from a subset of all of the individual oligonucleotide capture sequences for each sample. For example, the HA nets may only utilize signal inputs from oligonucleotide capture sequences designed specifically to target segments of the HA gene segment, while the NA nets may only utilize signal inputs generated from oligonucleotide capture sequences designed specifically to capture segments of the NA gene segment. Different combinations are also possible (e.g., HA nets use signals generated on both HA and M gene capture sequences, but not NA, NS or NP, . . . ).

Level 3 in the example provided in FIG. 10 represents information related to the animal host to which the virus is adapted. For example, there are differences in the genetic makeup of an H1N1 virus that is adapted to humans vs. an H1N1 virus adapted to birds and/or pigs. In this example, an ANN can be trained to distinguish between the H1 (or N1) gene segment of a human-adapted virus and the H1 (or N1) gene segment of a nonhuman-adapted virus. These ANNs should accept only signal inputs from oligonucleotide capture sequences targeted at the specific gene segment whose species of adaptation is to be determined. ANNs may be developed to target identification of a specific animal family for the gene segment in question (e.g., avian, porcine, canine, equine).

Principal Component Analysis

Another method that may be used in the present invention to simplify the architecture is to employ Principal Component Analysis on the dataset. If use of all individual inputs in determining the output does not provide the desired results, selective/intelligent pruning of the inputs (based on functional knowledge of individual captures, or analysis of weight factors/importance in determining output, or both) as well as other data reduction techniques such as principal component analysis may be used to simplify the inputs prior to the ANN analysis and reduce noise.

Using principal component analysis, the linear combinations of the input variables that account for the majority of the variability in the data are found. This is done via eigenvalue/vector analysis of the covariance of the inputs over all of the samples used for training. These linear combinations (the eigenvectors corresponding the largest eigenvalues) are then used as a reduced set of inputs into the ANNs for training. An algorithm for implementing Principal Component Analysis is given below.

1. Find the mean of each input:

$$\overline{x} = \frac{1}{N} {\sum }_{n = 1}^{N} {x}_{n} , \overline{x} = ( {\overline{x}}_{1} , … , {\overline{x}}_{k} )$$

k=# of inputs (individual oligonucleotides)
N=# of samples (i.e., size of the database)

2. Find the Covariance matrix of the inputs over the dataset:

$$COV = \frac{1}{N - 1} {\sum }_{n = 1}^{N} ( {x}^{n} - \overline{x} ) {( {x}^{n} - \overline{x} )}^{T}$$

3. Find the eigenvalues λᵢ and eigenvectors uᵢ of COV

The eigenvectors are the principal components (Covariance matrix is diagonal)

4. Project each sample onto the eigenvectors with the largest eigenvalues

a. top ˜20—various techniques can be used to determine the optimal number

5. Train as before, but #inputs is greatly reduced

Beneficial Aspects/Benefits:

Manual data interpretation of the relative intensities of a large number of inputs representing microarray data is difficult to impossible. Therefore, the structured use of supervised machine learning algorithms in the present invention to identify specific patterns in the data makes diagnosis straightforward and robust.

The data analysis method of the invention utilizing relative intensities of multiple gene segments allows for more flexibility than typical influenza assays. This attribute is particularly important for influenza characterization as new virus mutations emerge rapidly and frequently. Using the present methods, however, a new mutation is very likely to present a new pattern in the same microarray data. A simple re-training of one or more ANNs allows the software to be updated to recognize the new mutation with no changes to the hardware. In addition, a more general ANN, for example, one that recognizes all non-seasonal influenza A viruses, may recognize the new mutation without any additional training. Unsupervised learning methods (for example, K-means clustering) may also be used to identify new, emergent patterns from novel mutation(s). This may appear, for example, as Flu A positive, no known subtype. K-means clustering may be used to determine which samples to use as positive examples in a supervised learning process. This can be done in parallel with in-depth full genome sequencing, thereby jump-starting the training of a new ANN to recognize the emergent pattern in the critical early days (or hours) of a new outbreak or pandemic.

The approach of embodiments of the invention also involves division of the classification problem into smaller subsets. This allows analysis by more specialized individual algorithms whose boolean outputs are then logically combined. The benefits of this approach are greater simplicity in the individual ANNs, greater flexibility and isolation for testing, and greater robustness in the resulting diagnosis than is possible with a single, more complex ANN.

Typical influenza in vitro diagnostic assays (such as all of those based on PCR, real-time RT-PCR or other array-based assays such as the Luminex xTAG RVP assay or the eSensor RVP from Clinical Microsensors/GenMark Diagnostics) all utilize a similar approach—one single oligonucleotide “bit” results in one “bit” of information. This assay and analysis approach has low information content and is also prone to genetic mutations that may occur in the influenza virus in the target region(s), rendering the assay less effective or ineffective at detecting the intended target without a redesign of the detection sequences utilized.

In contrast, the data analysis approach of the invention (e.g., based on high information content microarray data) involves a much higher percentage of the overall genetic information available from the influenza virus, and therefore has significantly higher information content. This makes a data analysis method such as that described herein necessary, as a simple YES/NO answer for a single bit of information is not applicable. This higher information content data analysis results in an assay that is capable of providing more clinically and epidemiologically relevant information than currently-available tests.

In contrast to the traditional types of influenza diagnostic tests mentioned above that utilize 1 “bit” of information to make a diagnostic call, full genome sequencing represents the highest information content available to genetically characterize an influenza virus. It is well-known, however, that the data analysis associated with traditional full genome sequencing as well as next generation sequencing methods is labor-intensive and will prohibit immediate adoption of sequencing as a routine diagnostic technology. For example, see McPherson, JD. “Next Generation Gap”, Nature Methods 6, S2-S5 (2009).

The data analysis approach described here as applied to microarray data presents a middle ground, providing much higher information content than traditional influenza assays, but providing much simpler/faster data analysis that can be easily software-automated to ensure high ease of use in a clinical diagnostic setting.

### Example 1: Characterization of Influenza Using Supervised Learning

This example provides a description of methods for characterization of influenza viruses in samples using supervised learning with training microarray data sets corresponding to training samples characterized by one or more known pathogen parameters, such as influenza type, subtype, lineage, seasonality, presence of mutation/marker, etc.

A total of 1468 samples have been processed into microarray data sets. Samples included known positives of Flu A seasonal H1N1 and H3N2 subtypes, Flu B of both Victoria and Yamagata lineages, non-seasonal strains of A/H1N1 and A/H3N2, and a wide variety of swine- and avian-origin Flu A subtypes, clinical samples negative for flu, and samples negative for flu but positive for other pathogens that cause influenza-like illness. The clinical category of “non-seasonal Flu A” is very diverse genetically, and so can present a broad range of patterns on the microarray. For this embodiment, therefore, it is important to present as broad a collection patterns both of what is positive and what is negative. The latter are important to ensure that potentially cross-reactive organisms (e.g., other bacterial and viral pathogens that may cause influenza-like illness and would therefore be likely to be found in the collected specimens, e.g., adenoviruses, coronavirus, etc.) that may partially hybridize with some capture sequences on the microarray will be affirmatively recognized as negative for influenza.

Samples were obtained by a standardized assay process, including nucleic acid extraction, RT-PCR amplification with biotin-dUTP, and heat fragmentation. The microarray is then contacted with the sample under proper conditions to allow hybridization, fluorescently labeled and optically read out, thereby generating microarray data. The pre-processed microarray intensities for each influenza capture sequence on the microarray are used as the inputs to the pattern classification algorithm. Also included on the microarray are process controls for the hybridization and labeling steps, as well as an overall process control designed to target any samples of eukaryotic origin (e.g., an internal control). Each hybridization and internal control capture sequence is also printed in multiples of three as well so that the same nearest neighbor averaging (NNA) scheme can be used, though alternative spot quality control could also be used for the controls. Typical microarray patterns for representative strains of influenza are shown in FIG. 3. It is observed that the influenza-negative samples generated a signal on many of the inputs. While several of the spots are controls used to confirm successful completion of the assay process, many are oligonucleotides that target specific segments of the influenza genome. Some of these will also hybridize to some extent with either human DNA or nucleic acid from other pathogens. Without training these patterns as negative, they could be falsely identified as positive for a new strain of influenza.

Microarray data for each sample was pre-processed using nearest neighbor averaging (NNA) for all oligonucelotides and controls. Each of the oligonucelotides is printed on the microarray in triplicate, with the replicate spots scattered widely about the array. In theory, all three spots should produce similar fluorescence intensities. In practice, many factors can affect the individual signals, causing some spot values to be artificially high or artificially low. Typical signal distributions on the microarray are shown in the left plot of FIG. 4. With reasonably good process control from the microarray production to the assay process, it is rare for more than one of any three repeated spots to be an outlier. Thus, NNA greatly improves the data quality, as seen visually in the right plot of FIG. 4. The 2 remaining spots after eliminating the (highest or lowest) spot that is farthest from the middle spot results in the much tighter distribution of the right plot. The final value used is the average the two remaining spots.

Signal thresholds for the hybridization and labeling controls are established based on analysis of all available microarray data to enable the assessment of control failure prior to data processing. Controls for analyzed samples are then checked against previously established thresholds to ensure that the assay process did not fail. These controls ensure that the hybridization and labeling processes are successfully performed and that the reagents have not degraded or failed. Any failure in these process steps will result in decreased fluorescence intensities of the corresponding control spots, and an appropriate output such as “NO CALL—Control Failure” is reported rather than falsely reporting a negative result. The eukaryotic internal control is only analyzed when the result is negative for influenza due to potential PCR out-competition of the internal control in influenza-positive samples. Failure to detect the eukaryotic internal control in the absence of influenza virus may indicate that the sample and/or process was compromised in some way. This check can be bypassed if necessary for certain sample types.

For known influenza positive samples, additional checks against thresholds on specific capture sequences are implemented to ensure that the data used for training is of good quality (i.e., the signal is above the noise threshold). The specific oligonucelotides selected are known to be universally reactive to Flu A or Flu B. This check requires that the intensity of the specific oligonucleotide be greater than (e.g. two or three times greater) the mean of the background spots (e.g., spots with no printed capture sequence) plus three times the standard deviation of the background spots. Data from samples that pass all of the control checks outlined here are accumulated in the training dataset. The final training dataset consists of data from 1468 individual microarrays. Each of these was a unique assay, but the dataset includes only about 600 unique viral samples—about 467 of the assays processed were part of limit of detection studies wherein a single sample was diluted many times, with each dilution processed as a unique assay, and 401 samples were negative controls used for training only (potential cross-reacting pathogens, human specimen controls, etc.).

All of the training dataset was first separated by type (e.g., Seasonal H1N1, Seasonal H3N2, Flu B-Yamagata, Flu B-Victoria, Non-seasonal Flu A, Negative and Training only). Each of the types (except Training only) was then assigned evenly to six groups for training and cross-validation using the approach illustrated in FIG. 5. This process was used to train three independent “base” neural networks—one each to identify Flu A, Flu B and Negative, two FluB lineage networks (Yamagata and Victoria), and three FluA subtype networks (Seasonal H1N1, Seasonal H3N2 and Non-seasonal Flu A). All of these networks were single perceptron neural networks.

The summary performance for each network is determined by concatenating the outputs of each of the six training/validation combinations. A single threshold value is then chosen for each network that optimizes the network's performance metrics (maximize PPA & NPA while minimizing No Call %). The overall architecture used for the final determination of the call for each sample was that shown in FIG. 9. Example summary performance metrics and thresholds are shown below. Note that the Flu B lineage call assumes that only one lineage is present, as the output value of one the lineage networks must be at least 0.36 greater than that of the other lineage network.

TABLE 1
Example performance metrics and thresholds

| | PPA | | | NPA | | No Call/Invalid | | Subtype |
|---|---|---|---|---|---|---|---|---|
| n | TP/(TP + FN) | % | n | TN/(TN + FP) | % | # | #/total (%) | Indeterminate |

Flu A

| | | | | | | | | | |
|---|---|---|---|---|---|---|---|---|---|
| A/H1N1 | 187 | 186/(186 + 0) | 100.0% | 880 | 880/(880 + 0) | 100.0% | 0 | 0.0% | 1 |
| pdm | | | | | | | | | |
| A/H3N2 | 109 | 107/(107 + 1) | 99.1% | 958 | 958/(958 + 0) | 100.0% | 1 | 0.9% | 0 |
| Seasonal | | | | | | | | | |
| A/Non- | 259 | 251/(251 + 2) | 99.2% | 808 | 808/(808 + 0) | 100.0% | 0 | 0.0% | 6 |
| seasonal | | | | | | | | | |
| A Overall | 555 | 544/(544 + 3) | 99.5% | 512 | 512/(512 + 0) | | 1 | 0.2% | 7 |

Flu B

| | | | | | | | | | |
|---|---|---|---|---|---|---|---|---|---|
| Victoria | 90 | 87/(87 + 3) | 97% | 977 | 977/(977 + 0) | 100% | 0 | 0.0% | 0 |
| Lineage | | | | | | | | | |
| Yamagata | 43 | 43/(43 + 0) | 100% | 1024 | 1024/(1024 + 0) | 100.0% | 0 | 0.0% | 0 |
| Lineage | | | | | | | | | |
| B Overall | 133 | 130/(130 + 3) | 97.7% | 934 | 934/(934 + 0) | 100.0% | 0 | 0 | |

Currently, all Flu B samples available belong to either the Victoria lineage or the Yamagata lineage (or both if there is perhaps a dual infection that contains two influenza B viruses, one from each lineage). A single network could be used in which a low output value (close to zero) would indicate one lineage, and a high output value (close to one) would indicate the other lineage. Two independent networks are preferred. One reason for this preference is that the output values of the two networks can be summed. Ideally, the sum will always be one, but for samples where the lineage is difficult to determine, the sum is typically greater than one. As mentioned, a dual infection with both Victoria and Yamagata lineages present is also a possibility, and the sum of the two networks may give a better indication of this possibility.

TABLE 2
Influenza B Output

| | Sample | Yama | Victoria | |
|---|---|---|---|---|
| ID | type | Out | Out | Sum-1 |
| 1 | Yamagata | 0.996 | 0.004 | 0.000 |
| 2 | Victoria | 0.461 | 0.653 | 0.114 |
| 3 | Victoria | 0.014 | 0.987 | 0.001 |
| 4 | Victoria | 0.278 | 0.802 | 0.080 |
| 5 | Yamagata | 0.996 | 0.004 | 0.000 |
| 6 | Yamagata | 0.975 | 0.033 | 0.009 |
| 7 | Yamagata | 0.991 | 0.011 | 0.001 |
| 8 | Yamagata | 0.996 | 0.004 | 0.000 |
| 9 | Yamagata | 0.996 | 0.004 | 0.000 |
| 10 | Yamagata | 0.989 | 0.013 | 0.002 |
| 11 | Yamagata | 0.998 | 0.003 | 0.000 |
| 12 | Yamagata | 0.998 | 0.002 | 0.000 |
| 13 | Yamagata | 0.996 | 0.005 | 0.001 |
| 14 | Victoria | 0.032 | 0.974 | 0.006 |
| 15 | Victoria | 0.004 | 0.996 | 0.000 |
| 16 | Victoria | 0.004 | 0.996 | 0.000 |
| 17 | Victoria | 0.003 | 0.997 | 0.000 |
| 18 | Victoria | 0.669 | 0.430 | 0.099 |
| 19 | Victoria | 0.003 | 0.997 | 0.000 |
| 20 | Victoria | 0.003 | 0.997 | 0.000 |
| 21 | Victoria | 0.003 | 0.997 | 0.000 |
| 22 | Victoria | 0.003 | 0.997 | 0.000 |
| 23 | Victoria | 0.003 | 0.997 | 0.000 |
| 24 | Victoria | 0.003 | 0.997 | 0.000 |
| 25 | Victoria | 0.003 | 0.997 | 0.000 |
| 26 | Victoria | 0.007 | 0.994 | 0.000 |
| 27 | Victoria | 0.589 | 0.468 | 0.057 |
| 28 | Victoria | 0.006 | 0.994 | 0.000 |
| 29 | Victoria | 0.004 | 0.996 | 0.000 |
| 30 | Victoria | 0.004 | 0.996 | 0.000 |
| 31 | Victoria | 0.045 | 0.960 | 0.006 |
| 32 | Victoria | 0.004 | 0.996 | 0.000 |
| 33 | Victoria | 0.011 | 0.990 | 0.001 |
| 34 | Victoria | 0.004 | 0.996 | 0.000 |
| 35 | Victoria | 0.005 | 0.995 | 0.000 |
| 36 | Victoria | 0.003 | 0.997 | 0.000 |
| 37 | Victoria | 0.003 | 0.997 | 0.000 |
| 38 | Victoria | 0.004 | 0.997 | 0.000 |
| 39 | Victoria | 0.006 | 0.995 | 0.000 |
| 40 | Victoria | 0.003 | 0.997 | 0.000 |
| 41 | Victoria | 0.007 | 0.994 | 0.000 |
| 42 | Victoria | 0.003 | 0.997 | 0.000 |
| 43 | Yamagata | 0.998 | 0.002 | 0.000 |
| 44 | Yamagata | 0.998 | 0.002 | 0.000 |
| 45 | Victoria | 0.003 | 0.997 | 0.000 |
| 46 | Victoria | 0.003 | 0.997 | 0.000 |
| 47 | Yamagata | 0.998 | 0.002 | 0.000 |
| 48 | Yamagata | 0.997 | 0.003 | 0.000 |
| 49 | Victoria | 0.069 | 0.944 | 0.012 |
| 50 | Victoria | 0.003 | 0.997 | 0.000 |
| 51 | Victoria | 0.004 | 0.996 | 0.000 |

An enhanced database with 228 unique, newly obtained non-seasonal Flu A samples was used to train HA and NA specific networks to obtain the Level 2 information described in FIG. 10. The same 6-fold cross-validation process described above was used to determine the performance of each network. The results are shown below.

TABLE 3
Non-Seasonal HA Results

| | H1 | H3 | H5 | H7 | H9 |
|---|---|---|---|---|---|
| Samples | 239 | 212 | 105 | 106 | 24 |
| TP | 231 | 205 | 95 | 98 | 22 |
| FP | 9 | 5 | 4 | 5 | 4 |
| TN | 1082 | 1113 | 1221 | 1219 | 1302 |
| FN | 8 | 7 | 10 | 8 | 2 |
| PPA | 96.7% | 96.7% | 90.5% | 92.5% | 91.7% |
| NPA | 99.2% | 99.6% | 99.7% | 99.6% | 99.7% |

TABLE 4
Non-Seasonal NA Results

| | N1 | N2 | N7 | N8 | N9 |
|---|---|---|---|---|---|
| Samples | 308 | 247 | 41 | 71 | 42 |
| TP | 294 | 235 | 37 | 63 | 36 |
| FP | 16 | 9 | 6 | 4 | 5 |
| TN | 1006 | 1074 | 1283 | 1255 | 1283 |
| FN | 14 | 12 | 4 | 8 | 6 |
| PPA | 95.5% | 95.1% | 90.2% | 88.7% | 85.7% |
| NPA | 98.4% | 99.2% | 99.5% | 99.7% | 99.6% |

A subset of the training dataset consisting of only Flu A positive samples was used to identify the 119V mutation and the 275Y mutation. While this could be done with single perceptron neural networks, the presence or absence of these single nucleotide mutations can also be explored through examination of the comparative signals on very specific oligonucleotides on the microarray that span this mutation. This enables identification via thresholds of these specific oligonucelotides (or ratios of specific oligonucelotides) rather than using neural networks that look at the entire array of capture intensities.

Additional neural networks may be developed to further identify specific subtypes of non-seasonal Flu A (ex, H3N8, H5N2, H5Nx, H7Nx, etc.) These additional networks may be trained using all samples, only Flu A positive samples, or using only non-seasonal Flu A samples. For example, some subnetworks trained with the Flu A positive sample database have been explored. The number of positive samples is limited for all of these, but preliminary results follow.

H5N1—

The training database includes 11 positive samples for H5N1. Using the same 6-fold cross validation training/testing (one group had only one positive sample while the others each had two), ten of the 11 are correctly identified, with only 2 of 396 negative examples generating a false positive. Both of these false positives were non-seasonal Flu A's of a different type (one H2N2, one H9N2):

TABLE 5
H5N1

| H5N1 Network | |
|---|---|
| Threshold | 0.01 |
| True Positive | 10 |
| False Positive | 2 |
| True Negative | 394 |
| False Negative | 1 |
| Positive Percent Agreement | 90.9% |
| Negative Percent Agreement | 99.5% |

H3N8—

The training database includes 7 positive samples for H3N8. Using the same 6-fold cross validation training/testing (one group had two positive samples), six of the 7 are correctly identified, with only 1 of 400 negative examples generating a false positive. The false positive was another non-seasonal FluA of a different type (H2N9):

TABLE 6
H3N8

| H3N8 Network | |
|---|---|
| Threshold | 0.5 |
| True Positive | 6 |
| False Positive | 1 |
| True Negative | 399 |
| False Negative | 1 |
| Positive Percent Agreement | 85.7% |
| Negative Percent Agreement | 99.8% |

Swine-Origin H3N2—

The training database includes 16 positive samples for non-seasonal variants of H3N2 of swine origin. Using the same 6-fold cross validation training/testing, all 16 were correctly identified, with only 1 of 391 negative examples generating a false positive. Again, the false positive was another non-seasonal Flu A of a different subtype (H7N3):

TABLE 7
H3N2

| H3N2 Swine Network | |
|---|---|
| Threshold | 0.05 |
| True Positive | 16 |
| False Positive | 1 |
| True Negative | 390 |
| False Negative | 0 |
| Positive Percent Agreement | 100.0% |
| Negative Percent Agreement | 99.7% |

Once trained, the individual networks were logically connected as described in an example flowchart shown in FIG. 2. Note that NO CALL results when:
a. Labeling control fails, OR
b. Hybridization control fails, OR
c. Flu A, Flu B AND Negative networks are all negative (below a threshold cutoff), OR
d. Negative network is positive and either Flu A or Flu B network is positive, OR
e. Negative network is positive, Flu A and Flu B networks are negative, and Internal control fails.

### Example 2: Analysis of Microarray Data for Characterization of Influenza

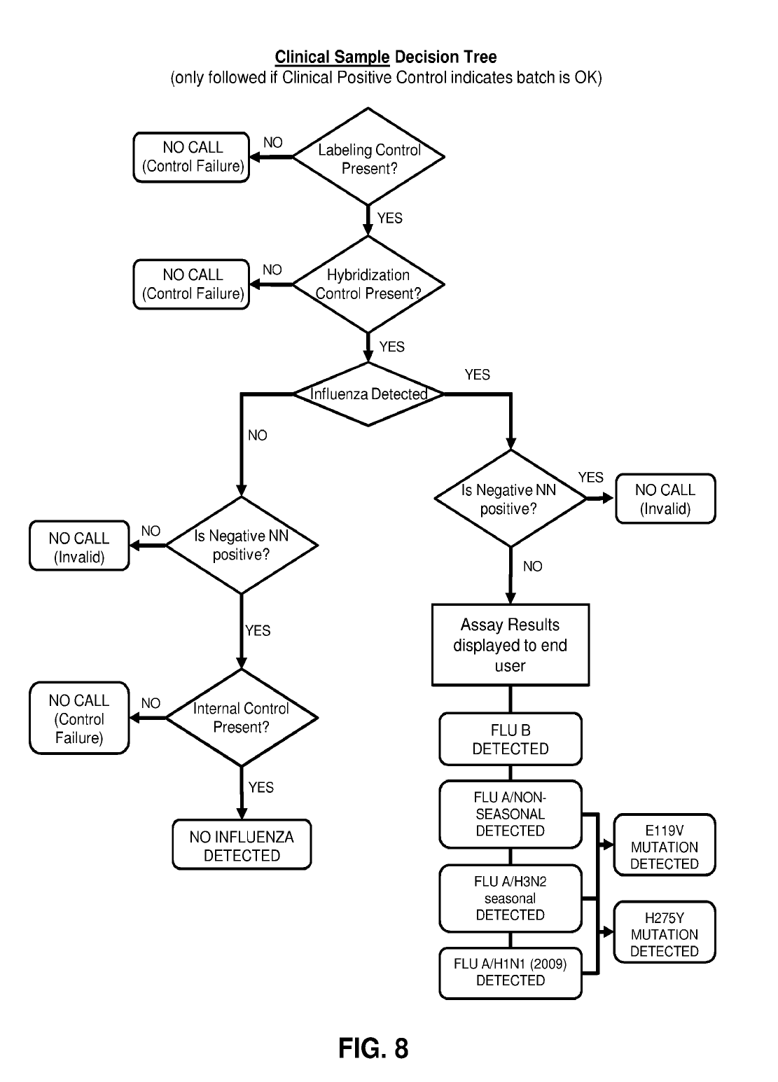

Rather than training the Flu A subtype networks on only Flu A positive samples, these networks could be trained using the entire dataset. FIG. 8 provides a flow diagram illustrating an example clinical sample decision tree of this aspects. In this case, the Influenza Detected block is positive when any of the influenza networks are positive (Flu B, Flu A seasonal H1N1, Flu A seasonal H3N2 or Flu A non-seasonal). NO CALL results whenever any of the networks are in conflict (e.g., all networks are negative, or the Negative network is positive along with one or more other networks, Flu A is negative while any of the FluA subtype networks are positive).

Performance metrics using this approach with an earlier dataset are shown below. While PPA & NPA performance is comparable to the method described in Example 1, the % No-Call increases.

TABLE 8
Performance Metrics for Example Dataset

| | H1N1 | H3N2 | Non-Seasonal A | Flu B |
|---|---|---|---|---|
| True Positive | 182 | 120 | 93 | 109 |
| False Positive | 4 | 9 | 2 | 5 |
| True Negative | 384 | 444 | 477 | 452 |
| False Negative | 4 | 1 | 2 | 0 |
| No Call | 16 | 16 | 16 | 21 |
| Positive Percent Agreement | 97.8% | 99.2% | 97.9% | 100.0% |
| Negative Percent Agreement | 99.0% | 98.0% | 99.6% | 98.9% |
| No Call % | 2.7% | 2.7% | 2.7% | 3.6% |

### Statements Regarding Incorporation by Reference and Variations

All references cited throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

It must be noted that as used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are now described. Nothing herein is to be construed as an admission that the invention is not entitled to antedate such disclosure by virtue of prior invention.

Every formulation or combination of components described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. As used herein, ranges specifically include the values provided as endpoint values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

### REFERENCES

US Application no. 20090124512
US Application no. 20100130378
US Application no. 20100273670
US Application no. 20140221234
Heil, G L, McCarthy, T, Yoon, K-J, Darwish, M, Smith, C B, Houck, J A, Dawson, E D, Rowlen, K L, Gray, G C “MChip, a low density microarray, differentiates among seasonal human H1N1, classical swine H1N1, and the 2009 pandemic H1N1”, Influenza Other Respir Viruses 2010, 4(6), 411-416.
Townsend, M B, Smagala, J A, Dawson, E D, Deyde, V, Gubareva, L, Klimov, A I, Kuchta, R D, Rowlen, K L, “Detection of Adamantane-Resistant Influenza on a Microarray”, J Clin Virol 2008, 42(2), 117-123.
Moore, C L, Smagala, J A, Smith, C B, Dawson, E D, Cox, N J, Kuchta, R D, Rowlen, K L “Evaluation of MChip with Historic A/H1N1 Influenza Viruses Including the 1918 “Spanish Flu’” J Clin Microbiol 2007, 45(11), 3807-3810.
Mehlmann, M, Bonner, A B, Williams, J V, Dankbar, D M, Moore, C L, Kuchta R D, Podsiad, A B, Tamerius, J D, Dawson, E D, Rowlen, K L “Comparison of the MChip to Viral Culture, Reverse Transcription-PCR, and the QuickVue Influenza A+B Test for Rapid Diagnosis of Influenza” J Clin Microbiol 2007, 45: 1234-1237.
Dankbar, D M, Dawson, E D, Mehlmann, M, Moore, C L, Smagala, J A, Shaw, M W, Cox, N J, Kuchta, R D, Rowlen, K L. “Diagnostic microarray for influenza B viruses” Anal Chem 2007, 79(5), 2084-2090.
Dawson, E D, Moore, C L, Dankbar, D M, Mehlmann, M Townsend, M B, Smagala, J A, Smith, C B, Cox, N J, Kuchta, R D, Rowlen, K L “Identification of A/H5N1 influenza viruses using a single gene diagnostic microarray” Anal Chem 2007, 79(1), 378-384.
Dawson, E D, Moore, C L, Smagala, J A, Dankbar, D M, Mehlmann, M Townsend, M B, Smith, C B, Cox, N J, Kuchta, R D, Rowlen, K L “MChip: A tool for influenza surveillance” Anal Chem 2006, 78(22), 7610-7615.
Dawson, E D, Rowlen, K L “MChip: A Single Gene Diagnostic for Influenza A”, in Influenza: Molecular Virology, Wang, Q. and Tao, Y. J., eds. (Norfolk, UK, Caister Academic Press), February 2010, book chapter.

1. A method for characterizing one or more target pathogens, said method comprising:
providing a microarray having a plurality of capture sequences;
contacting said microarray with a sample derived from a material potentially containing said target pathogens, wherein analytes in said sample bind to a least a portion of said plurality of capture sequences;
reading out said microarray contacted with said sample, thereby generating microarray data;
analyzing said microarray data using a plurality of independent supervised learning algorithms; wherein at least a portion of said independent supervised learning algorithms independently provide outputs corresponding to pathogen parameters of said one or more target pathogens, wherein each of said independent supervised learning algorithms are independently trained using supervised learning with training microarray data sets corresponding to training samples characterized by one or more known pathogen parameters; and
combining said outputs for at least a portion of said independent supervised learning algorithms to make a determination, thereby characterizing said one or more target pathogens.

2-4. (canceled)

5. The method of claim 1, wherein said material potentially containing said target pathogens that is suspected of containing influenza.

6. (canceled)

7. The method of claim 1, wherein said determination is an identification of the presence or absence of said one or more target pathogens.

8. The method of claim 1, wherein said determination is an identification of one or more pathogen parameters of a target pathogen.

9. The method of claim 1, further comprising the step of retraining at least a portion of said independent supervised learning algorithms so as to recognize a new strain of said one or more target pathogens.

10. The method of claim 1, wherein each of said independent supervised learning algorithms is independently trained to evaluate a single pathogen parameter of a target pathogen.

11. The method of claim 1, wherein each of said independent supervised learning algorithms is independently trained to evaluate a different pathogen parameter of one or more of said target pathogens.

12. (canceled)

13. The method of claim 1, wherein at least a portion of said independent supervised learning algorithms are independent artificial neural network (ANN) algorithms.

14. (canceled)

15. The method of claim 1, wherein at least a portion of said independent supervised learning algorithms are independently trained via a backpropagation method.

16-17. (canceled)

18. The method of claim 1, wherein at least a portion of said independent supervised learning algorithms are trained solely on a single known pathogen type to identify the presence or absence of one or more distinguishing attributes or pathogen subtypes.

19. The method of claim 1, wherein at least a portion of said independent supervised learning algorithms are independently trained using training microarray data for training samples characterized by the presence of a target pathogen having one or more known pathogen parameters.

20-21. (canceled)

22. The method of claim 19, wherein said known pathogen parameters are selected from the group consisting of: type, subtype, genotype, absence of pathogen, strain, lineage, seasonality, mutation presence or absence, marker presence or absence, and any combination of these.

23. The method of claim 19, wherein said pathogen is one or more influenza viruses and wherein said pathogen parameters correspond to influenza A, influenza B, influenza A seasonal H1N1 subtype, influenza A seasonal H3N2 subtype, influenza A non-seasonal subtype, H5N1 subtype, H5N2 subtype, H7N9 subtype, H9N2 subtype, H3N8 subtype, pathogenicity marker, 275Y NA mutation or 119V NA mutation.

24-29. (canceled)

30. The method of claim 1, wherein at least one of said plurality of independent supervised learning algorithms provides outputs corresponding to a host species to which said target pathogen has adapted.

31. The method of claim 1, wherein at least a portion of said independent supervised learning algorithms utilize a reduced set of inputs derived from a total set of inputs via Principal Component Analysis.

32. (canceled)

33. The method of claim 1, wherein at least a portion of said independent supervised learning algorithms each independently provides a score corresponding to a pathogen parameter of said target pathogens.

34. (canceled)

35. The method of claim 33, wherein said pathogen parameters are selected from the group consisting of: type, subtype, genotype, absence of pathogen, strain, mutation presence or absence, marker presence or absence and any combination of these for said target pathogens.

36. The method of claim 33, wherein each score is independently compared to a corresponding threshold to determine if the output is positive or negative for a given pathogen parameter.

37. The method of claim 36, wherein each threshold is independently determined by maximizing positive percentage agreement, negative percentage agreement or both.

38. The method of claim 1, wherein outputs of at least a portion of said independent supervised learning algorithms are logically combined to make said determination.

39-42. (canceled)

43. The method of claim 38, wherein logically combining said outputs comprises determining if an influenza A or influenza B target pathogen is detected.

44. The method of claim 43, wherein, in the event influenza B is identified, logically combining said outputs further comprises identifying the lineage of said influenza B target pathogen.

45. (canceled)

46. The method of claim 43, wherein, in the event influenza A is identified, logically combining said outputs further comprises identifying seasonal H1N1, seasonal H3N2 or non-seasonal subtype.

47-49. (canceled)

50. The method of claim 46, wherein, in the event non-seasonal subtype is identified, logically combining said outputs further comprises identifying H5N1, H5N2, H7N9, H9N2, or H3N8 subtype.

51-56. (canceled)

57. The method of claim 1, wherein said step of reading out said microarray comprises measuring relative intensities of light from at least a portion of said capture sequences.

58-59. (canceled)

60. The method of claim 1, said method further comprising pre-processing said microarray data prior to said step of analyzing said microarray data.

61. The method of claim 60, wherein said pre-processing comprises calculating intensity values for a plurality of spots of said microarray corresponding to the same capture sequence and comparing said intensity values.

62. The method of claim 60, wherein said pre-processing comprises statistically combining intensity values corresponding to a subset of said plurality of spots of said microarray corresponding to the same capture sequence.

63. The method of claim 60, wherein said step of pre-processing said microarray data is carried out using a nearest neighbor analysis.

64-70. (canceled)

71. A method for analyzing microarray data for characterizing one or more target pathogens, said method comprising:
providing said microarray data;
analyzing said microarray data using a plurality of independent supervised learning algorithms; wherein at least a portion of said independent supervised learning algorithms independently provide outputs corresponding to pathogen parameters of said one or more target pathogens, wherein each of said independent supervised learning algorithms are independently trained using supervised learning with training microarray data sets corresponding to pre-characterized training samples characterized by one or more known pathogen parameters; and
combining said outputs for at least a portion of said independent supervised learning algorithms to make a determination, thereby characterizing said one or more pathogens.

72. A system for analyzing microarray data for characterizing one or more target pathogens, said system comprising:
a processor configured to:
receive microarray data as an input;
analyze said microarray data using a plurality of independent supervised learning algorithms; wherein at least a portion of said independent supervised learning algorithms independently provide outputs corresponding to pathogen parameters of said one or more target pathogens, wherein each of said independent supervised learning algorithms are independently trained using supervised learning with training microarray data sets corresponding to pre-characterized training samples characterized by one or more known pathogen parameters;
combine said outputs for at least a portion of said independent supervised learning algorithms to make a determination; and
generate a diagnostic output corresponding to said determination.
